(19) United States
(12) Patent Application Publication
(10) Pub. No.: US 2005/0230240 A1
(43) Pub. Date: Oct. 20, 2005

(54) Method and apparatus for carbon allotropes synthesis

(76) Inventors: Roman Dubrovsky, Bronx, NY (US); Valeriy Bezmelnitsyn, East Newark, NJ (US)

Correspondence Address: Roman Dubrovsky, 4525 Henry Hudson Prkwy, Apt. B701, Bronx, NY, 10471, US

(21) Appl. No.: 10/796,458

(22) Filed: Mar. 9, 2004

(51) Int. Cl. B01J 19/08

(52) U.S. Cl. 204/164; 422/186.04

(57) ABSTRACT

A method and apparatus for synthesis of fullerenes and nanotubes in large quantities at an economical cost from graphite in electric arc plasma process are presented. Different embodiments of channeled graphite electrodes for both direct current (DC) and alternative current (AC) processes are disclosed. High productivity of the carbon allotropes is achieved by feeding consumable graphitic electrode into hot plasma zone, injecting of feedstock, catalyst and buffer gas flow through the longitudinal inner channel electrodes into the hot plasma zone and creating the radial gas outflow in the gap between electrodes, and following removal of produced carbon and catalytic vapors from the hot plasma zone into an oxygen deprived reaction vessel for quenching and condensing. Deposited after condensation soot containing carbon allotropes is collected and carbon allotropes are recovered by known techniques. The final products of recovering are fullerenes C₆₀, C₇₀ and higher fullerenes or nanotubes.

### BACKGROUND OF THE INVENTION

In 1985 Robert F. Curl and Richard E. Smalley from Rice University working together with Harold W. Kroto from University of Sussex reported that a new form of carbon could be made by laser irradiation of graphite electrode to produce soot in an evaporation chamber [H. W. Kroto et. al., “C₆₀ Buckminsterfullerene”, Nature, 318, 162-163 (1985)]. In 1990 W. Kreatchmer and D. Huffman announced that they found more simple way to produce the mixture of C₆₀ & C₇₀ by striking an arc between two graphite electrodes and forming soot from the vaporized carbon [W. Kreatchmer et. al., “Solid C₆₀: A new form of carbon”, Nature, 347, 354-357 (1990)]. The method was very simple but production rates were too small, about 1 gram/hour.

Later on some alternative techniques were introduced like a sputtering method disclosed in the U.S. Pat. No. 5,494,558, where fullerene-containing soot was prepared by bombardment of a carbon target with sufficient amount of positive ions in the presence of inert gas and a gas combustion method disclosed in U.S. Pat. No. 5,273,729, where fullerenes were produced by burning carbon-contained compounds in a flame and collecting the condensable vapor. Recent U.S. Pat. No. 5,876,684 discloses the various methods of high energy sources usage such as laser beams, arc discharge, induction heating and RF plasma to synthesize fullerenes from carbon particulates, liquid and gaseous hydro-carbon materials, U.S. Pat. No. 6,645,438, trying to overcome deficiency of previously known methods and embodiments in order to invent a process capable to scale up fullerenes synthesis rate. All these and many other methods represent significant departure from electric arc plasma method but their production rates were still not enough to organize large-scale industrial process to produce fullerenes in large quantities and at low price.

Wide variety of methods for synthesizing nanotubes is described in the literature [M. J. Yacaman et. al./Appl. Phys. Lett. 63, 202 (1993); C. Bower et. al./Appl. Phys. Lett. 77, 2767, (2000); W. K. Hsu et. al./Nature, 377, 687 (1995) and Chem. Phys. Lett. 262, 161 (1996); W-S. Cho et. al./Appl. Phys. Lett. 69, (1996); Y. L. Li et. al./Matter Res. 12, 613 (1997); A. Pigneyet et. al./J. Mater. Res. 12, 613 (1997); M. D. Diener et. al./J. Phys. Chem. B. 104, 9615 (2000); V. N. Bezmel'nitsyn et. al./Physics of the solid state, Vol. 44, 4, 656-658 (2002)]. These methods apply thermo-catalytic destruction of hydro-carbons, chemical deposition of hydrocarbon vapor, electrochemical spark discharge in liquid electrolytes; chemical conversion of solid polymers; solid state pyrolysis of high melted carbon content compounds; direct catalytic conversion of composite powders and resent synthesis of NT and fullerenes in flames from hydro-carbons (US Patents # 6645438, 6162411, 5985232, Japan Patent Publication # 2000-109309).

Though all prior methods exhibit limited applicability, electric arc discharge between graphite electrodes was historically the most common method for the purposes of macroscopic production of carbon allotropes such as fullerenes and nanotubes. The productivity of the arc plasma method depends on the total mass of evaporated graphite and carbon allotropes yield. The simplest way to increase productivity was to apply higher electrical currents. But it was found that there is specific interval of electrical currents, where fullerene production had the highest values. For example, graphite electrodes of 6-10 mm in diameter require 80-150 A of current. Applying higher electrical currents will increase the total mass of vaporized graphite but dramatically will reduce fullerene yield. In spite of endless improvements of the arc plasma process typical fullerene yields did not exceed 10-15% mass [Y. Saito et. al., “Yield of fullerenes generated by contact arc method under He and Ar: dependence on gas pressure”, Chem. Phys. Lett., Vol. 200, 6, 643-648 (1992)] and the total fullerene productivities rarely exceeded 10-30 g/h. Cathode deposit growth, strong UV radiation, insufficient quenching rates at high currents and small diameters of electrodes were the four main limitations of the electric arc plasma method. Below we are considering the influence of all these factors on carbon allotropes productivity in greater details.

Evaporation of anode in direct current (DC) electric arc plasma process produces carbon vapors for the carbon allotropes synthesis. In this process some part of the carbon vapors move out of the gap between electrodes and serves as a material for carbon allotropes synthesis but some part approaches relatively cold surface of cathode and precipitate there forming hard carbon deposit. Cathode deposit is a troublesome phenomenon in electric arc plasma process. As much as 40-50% mass of evaporated anode may be transformed into useless cathode deposit instead of being converted into carbon allotropes contained soot [J. M. Jones et. al., “The anode deposit formed during the carbon-arc evaporation of graphite for the synthesis of fullerenes and carbon nanotubes”, Carbon, Vol. 34, 2, 231-237 (1996)]. Higher electrical currents increase carbon vapors density in the gap area, which dramatically increases the percentage of cathode deposit. Authors of the present invention experienced the situations when almost all evaporated carbon from anode was transformed into cathode deposit at direct currents of 400-500 A. Applying the alternative current (AC) reduces the deposit growth rate but does not eliminate it at all.

Strong UV radiation is another serious limitation for carbon allotropes productivity in the electric arc plasma method. UV radiation destroys carbon allotropes precursors converting them into amorphous soot particles. In the traditional arc plasma process carbon vapors experience relatively long residence times in hot plasma zone. Because higher electrical currents produce more powerful electric arc with stronger UV radiation carbon allotropes yield sharply drops down.

It was experimentally found that for the most successful fullerene formation quenching rates of about 1000-2500 K per second are required [U.S. Pat. No. 6,099,696]. It means carbon vapors have to be removed outward of the hot plasma zone and cooled down very rapidly. Usage of higher currents creates larger hot plasma zone, requires higher quenching rates and, as a rule, decreasing the fullerene yield.

In the traditional electric arc plasma method the best carbon allotropes productivities were obtained using electrodes with diameters 6-10 mm. Such thin electrodes are fragile and fast consumable. They are also very expensive to manufacture. To ensure successful commercializing of the electric arc plasma method graphite electrodes have to be noticeably bigger.

It was proved that continuous inert gas flow introduced to an electric arc plasma reactor exerts positive influence on the carbon allotrope yields [U.S. Pat. Nos. 5,493,094, 5,393,955, 5,300,203, 5,304,366, 5,227,038, Japan Patent Publications # 2001-019412, 08-217430, 06-183712 and WIPO patent application WO02/096800]. Though carbon allotrope yields were increased, the overall productivity remained low. Furthermore, the problems of cathode deposit growth and usage of small electrode diameters were still keeping the electric arc plasma method far away from being utilized for production of fullerenes and nanotubes in bulk.

In contrast to the existing inventions the present invention presents the different way of buffer gas flow introduction to the plasma reactor. The buffer gas is injected through inner channels in electrodes to the between electrode gap, or to the very core of the hot plasma zone. It creates radial gas outflow and rapidly, and forcefully removing developed fresh carbon vapors outward of the hot plasma zone. The present invention allows to eliminate cathode deposit growth, to use electrodes of bigger diameters, to provide extremely low residence times of the carbon vapors in the hot plasma zone, which prevents newly formed carbon allotrope precursors from destruction, to ensure very high quenching rates, reasonable yields and outstanding overall carbon allotrope productivity. The present invention also provides an apparatus, which can be scaled up to satisfy industry needs for mass production.

### SUMMARY OF THE INVENTION

The present invention introduces the improved method for synthesis of carbon allotropes such as fullerenes and nanotubes in the DC and AC electric arc plasma processes. The method comprises injection of buffer gas flow through at least one longitudinal inner channel of at least one graphite electrode to the between electrode gap, which represents the core of the hot plasma zone, and creating a radial gas outflow; starting an electric arc and maintaining the hot plasma zone in the gap between graphite electrodes; admixing carbonic feedstock and catalyst for nanotubes synthesis with buffer gas flow; feeding admixed carbonic feedstock, catalyst and at least one of the graphite electrode to the hot plasma zone; producing carbon and catalyst vapors in the gap between electrodes; rapidly removing carbon and catalyst vapors outward of the hot plasma zone by the invented radial gas outflow; quenching and condensing carbon and catalyst vapors; producing soot containing the carbon allotropes; collecting the produced soot and the carbon allotropes recovering.

Graphite electrodes are used as the main source of carbon. To reduce graphite electrodes consumption carbonic feedstock comprising fine-dispersed carbon such as carbon soot, carbon dust, graphite powder, calcinated coke powder, acetylene black and their mixtures as well as any gaseous and liquid compounds containing carbon can be also used as a source of carbon. Metal catalyst in a form of fine-dispersed powders, liquid or gaseous compounds, as well as metal wire or strip inserts in graphite electrodes assemblies is applied for carbon nanotubes synthesis.

The present invention also introduces an apparatus for synthesis of carbon allotropes, such as fullerenes and nanotubes in the DC and AC electric arc plasma processes. The apparatus comprises a vacuum-sealed reaction vessel; movable electrode holders with attached electrodes; at least one inner gas channel coming through at least one electrode holder and electrode; electrically insulated bush seals assembled vacuum-tight with the movable electrode holders; gas inlet; gas outlet; temperature resistant filtration system; re-circulation gas line with re-circulation gas pump; vacuum system; gas supply system; AC or DC power system; water-cooling system; carbonic feedstock and catalyst feeding system.

In addition to the apparatus of the present invention five preferred embodiments of electrode design are presented. Three preferred embodiments are to be employed as non-consumable cathodes in DC arc plasma process and serve as buffer gas flow distributors to eliminate the problem of cathode deposit. They include: multiple-channel electrode with branched channels, multiple-channel electrode with additional annular channel and multiple-channel electrode with parallel channels having special outlets. Another two preferred embodiments disclose the electrode designs, which are to be employed as consumable anodes in DC arc plasma process or as both electrodes in AC arc plasma process. They offer an easy and inexpensive way of creating a gas-tight longitudinal inner gas channels in an expendable electrode and allows to introduce metallic catalyst in the form of metal wires or strips used in carbon nanotubes synthesis. They include assemblies of graphite rods of different geometry with or without metal catalyst inserts.

### BRIEF DESCRIPTION OF THE DRAWINGS

FIG. 1. depicts a method of the invention, comprising injection of buffer gas through longitudinal inner channels in electrodes and creating a radial gas outflow.

a), b) and c) depict different ways of creating radial gas outflow in the gap between anode and cathode in DC arc discharge plasma process.

FIG. 2. depicts the apparatus of the present invention, comprising channeled cathode and anode.

View A shows in details the radial gas outflow in the gap between electrodes.

FIG. 3. depicts a vertical cross-sectional view of the first preferred embodiment of electrode design, showing gas flow distribution through the branched multiple-channel cathode to create radial gas outflow.

View A-A depicts the distribution of channel outlets at the cathode end.

FIG. 4. depicts a vertical cross-sectional view of the second preferred embodiment of electrode design, showing gas flow distribution through the branched multiple-channel cathode with annular channel to create radial gas outflow.

View A-A depicts the distribution of channel outlets at the cathode end.

FIG. 5. depicts a vertical cross-sectional view of the third preferred embodiment of electrode design, showing gas flow distribution through the multiple-channel cathode with parallel channels to create radial gas outflow.

View A-A depicts the distribution of channel outlets at the cathode end.

a), b) and c) depict variations in channel outlet design, comprising straight, chamfered and fillet outlets.

FIG. 6. depicts the fourth preferred embodiment of electrode design, showing gas flow distribution through the inner longitudinal gas channel of anode assembled from three graphite rods to create radial gas outflow.

View A-A depicts the horizontal cross-section of anode.

a), b) and c) depict variations in anode assembling having graphite rods of different geometry with catalyst inserts for nanotube synthesis.

FIG. 7. depicts the fifth preferred embodiment of electrode design, showing gas flow distribution through the multiple inner longitudinal gas channels of anode assembled from nine graphite rods with metal catalyst wires or strips between them to create radial gas outflow.

View A-A depicts the horizontal cross-section of anode.

View B-B depicts the vertical cross-section of anode.

### DETAILED DESCRIPTION OF INVENTION

It is an object of this invention to provide an improved method for synthesis of carbon allotropes, such as C₆₀, C₇₀ and higher fullerenes mixture as well as nanotubes to overcome the problem of their low productivity and high cost. The method comprises injection of buffer gas flow through at least one longitudinal inner channel of at least one graphite electrode to the between electrode gap and creating a radial gas outflow removing forcefully carbon vapor outward of the hot plasma zone. The radial gas outflow reduces residence time of carbon allotropes precursors in the hot plasma zone, subjected to the harmful UV radiation, eliminates hard cathode deposit, and increases quenching rates. This approach allows to apply the higher electrical currents and usage of graphite electrodes with bigger diameters without suffering of any substantial reduction of the carbon allotrope yields and allows significantly increase fullerene productivity.

It is another object of the present invention to provide a method to reduce graphite electrodes consumption by continuous admixing carbonic feedstock comprising fine-dispersed carbon or carbon-containing gaseous and liquid compounds with buffer gas flow and injecting them through at least one longitudinal inner channel of at least one graphite electrode to the hot plasma zone. Feeding of carbonic feedstock directly to the between electrode gap, which represents the very core of the hot plasma zone, ensures effective and full evaporation of said carbonic feedstock.

It is another object of the present invention to provide a method of carbon nanotubes synthesis by applying a metal catalyst. The catalyst is supplied to the hot plasma zone in the form of fine-dispersed powders, liquid or gaseous compounds by its admixing with buffer gas flow and injecting through at least one longitudinal inner channel of at least one graphite electrode to the hot plasma zone. The catalyst can be also supplied to the hot plasma zone as metal wire or strip inserts in graphite electrodes assemblies.

It is another object of the present invention to provide an apparatus for synthesis of said carbon allotropes comprising ability to introduce continuous buffer gas flow with admixed carbonic feedstock and metal catalyst to the core of the hot plasma zone; provide their effective evaporation; rapidly remove carbon and catalyst vapors outward of the hot plasma zone for quenching of vapor and condensation. Admixing carbonic feedstock only or carbonic feedstock together with metal catalyst allows synthesizing both fullerenes and nanotubes using the same apparatus.

It is another object of the present invention to provide an buffer gas re-circulation line with separation module for maintaining close loop system, where reaction products are forced to exit reaction vessel, solid products are separated by temperature resistant filter and buffer gas is collected and reused. The re-circulation line provides additional savings on buffer gas.

It is another object of the present invention to provide multiple-channel embodiments of non-consumable graphite electrodes to distribute buffer gas flow within the electrode body to improve gas dynamic of the radial gas outflow.

It is another object of the present invention to provide embodiments of non-consumable graphite electrodes to create specific gas shields to cut-off carbon vapor streams directed toward cathode sidewall in order to eliminate side hard cathode deposit.

It is another object of the present invention to provide embodiment of consumable and non consumable electrodes used with DC current to develop the hot plasma zone with ability to perform alternative functions for cathode and anode by temporarily changing a polarity of electrodes and convert temporarily cathode to consumable anode and anode to non consumable cathode to consume the developed deposit on cathode surface in order of complete elimination of the build up deposit on the cathode surface.

It is another object of the present invention to provide embodiments of consumable graphite electrodes comprising an assembling of several graphite rods with or without inserts of metal catalytic wires or strips between them composing at least one inner gas channel for delivering buffer gas and carbonic feedstock to the hot plasma zone.

It is another object of the present invention to provide embodiments with inclination ability to intensify a condensation rate of soot on reaction vessel walls, to reduce maximum heat load on reaction vessel body, make easier discharge of produced soot from the vessel and improve access to electrode changer.

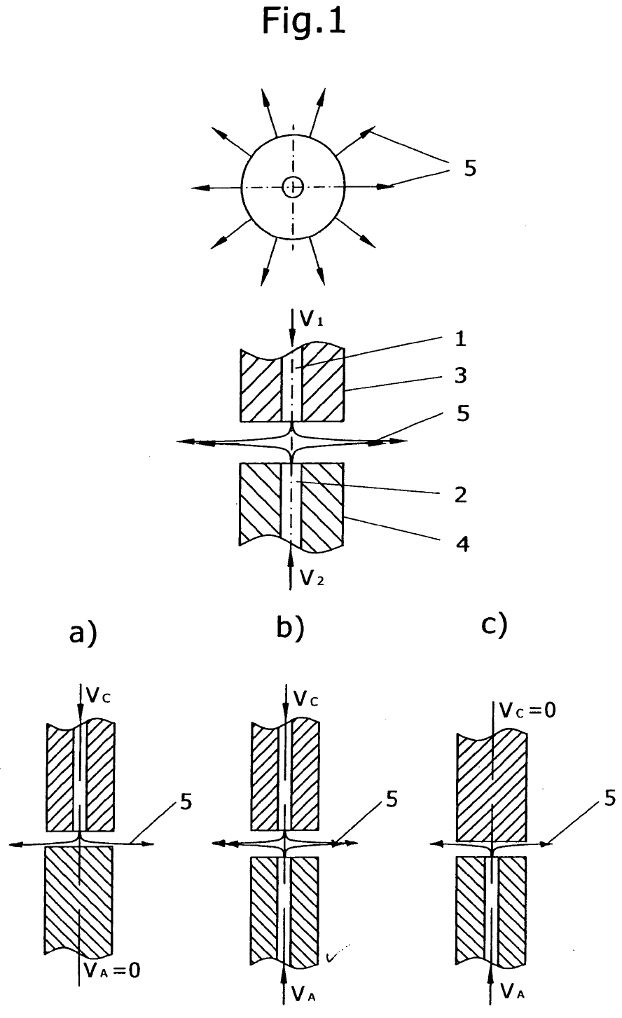

Present invention introduces the method and apparatus for synthesis of carbon allotropes such as fullerenes and nanotubes in electric arc plasma process. The method of the present invention shown on FIG. 1 comprises injection of gas flows V₁ and V₂ through longitudinal inner gas channels 1 and 2 of carbonic electrodes 3 and 4 to a gap between the electrodes and creating a radial gas outflow 5; starting an electrical arc and maintaining the hot plasma zone in the gap between electrodes 3 and 4; admixing carbonic feedstock and catalyst for nanotubes synthesis to at least one of the injected gas flows V₁ and V₂; feeding admixed carbonic feedstock, catalyst and at least one of the carbonic electrodes 3 and 4 to the hot plasma zone; producing carbon and catalyst vapors in the gap between electrodes 3 and 4; removing carbon and catalyst vapors outward of the hot plasma zone by the radial gas outflow 5; quenching and condensing carbon and catalyst vapors; producing soot containing the carbon allotropes; collecting the produced soot and the carbon allotropes recovering. The recommended inert gas for creation of buffer gas outflow besides pure helium can be mixture of helium with up to 20% of argon and/or mixture helium and 10% of nitrogen. The method of the present invention is applicable for both direct current (DC) and alternative current (AC) arc plasma processes. Subfigures 1a, 1b and 1c depict three possible ways of creating the radial gas outflow (5) in the gap between anode and cathode in DC arc plasma process. The radial gas outflow can be created by injection of gas flow V_{C} to the inner longitudinal gas channel of cathode, by injection of gas flow V_{A} to the inner longitudinal gas channel of anode or by simultaneous injection of both gas flows V_{C} and V_{A} to cathode and anode.

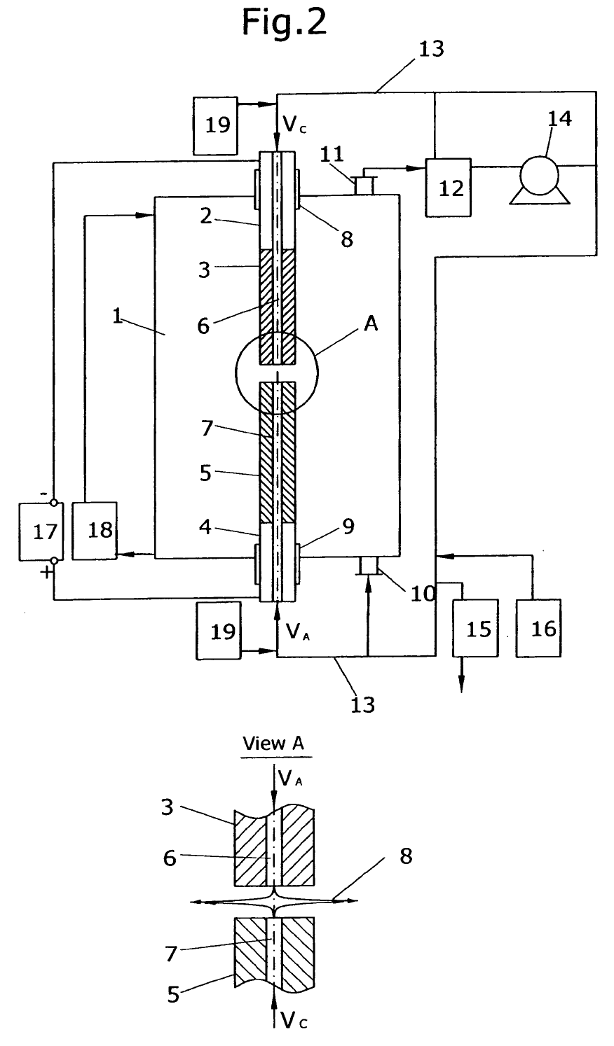

The apparatus of the present invention shown on FIG. 2 utilizes the described above method for DC arc plasma process and comprises a vacuum-sealed reaction vessel 1; movable cathode holder 2 with attached cathode 3; movable anode holder 4 with attached anode 5; longitudinal inner gas channel 6 coming through cathode holder 2 and cathode 3; longitudinal inner gas channel 7 coming through anode holder 4 and anode 5; electrically insulated bush seals 8 and 9 assembled vacuum-tight with the movable electrode holders 2 and 4; gas inlet 10; gas outlet 11; filtration system 12; re-circulation gas line 13 with re-circulation gas pump 14; vacuum system 15; gas supply system 16; DC power system 17; water-cooling system 18; carbonic feedstock and catalyst feeding system 19.

The operation of the apparatus starts when the reaction vessel 1 is assembled and vacuummized by vacuum system 15. Then the reaction vessel is backfilled with fresh buffer gas from the gas supply system 16. The process is repeated 2-3 times to make sure no more oxygen and moisture traces left in the reaction vessel. Then water-cooling system 18 starts. After that gas re-circulation pump 14 starts and supplies the required buffer gas flows V_{C} and V_{A} to the longitudinal inner gas channels 6 and 7. The buffer gas flows V_{C} and V_{A} proceed to the gap between anode 5 and cathode 3 and create radial gas outflow 8. Then power system 17 starts, positive electrical contact of which is connected to anode 5 through the movable anode holder 4 and negative electrical contact is connected to cathode 3 through the movable cathode holder 2. Electrodes 3 and 5 are moved towards each other till their direct contact and then electric arc is started. After that electrodes are pulled apart and form a gap, which is automatically maintained during the process providing constant and stable plasma zone, as well as continuous rate of anode 5 evaporation. Any other methods of arc starting besides direct contact of electrodes are also in the scope of the invention. At the same time feeding system 19 admixes carbonic feedstock to the gas flow in the re-circulation line 13. The said feeding system 19 admixes fine-dispersed metal catalyst to buffer gas flow in re-circulation line 13 to enable synthesis of carbon nanotubes at the same apparatus of the present invention. Carbonic feedstock and catalyst are injected with buffer gas flows Vc and VA into the gap between anode 5 and cathode 3. Anode 5, carbonic feedstock and catalyst evaporate and radial gas outflow 8 removes carbon and catalyst vapors outward of the hot plasma zone to the volume of reaction vessel 1, where the produced vapors are quenched and condensed. To provide greater rates of quenching, larger carbon allotropes yields, and higher productivity embodiment allows to control buffer gas outflow rate. In addition, cool inert gas can be introduced through the gas inlet 10 into the reaction vessel 1. Quenching and condensing of carbon and catalyst vapors forms carbon soot, containing carbon allotropes. Carbon soot deposits on the inner walls of the reaction vessel 1 and partly moves with buffer gas flow through gas outlet 11 and is collected in the filter system 12.

The arc plasma process of carbon allotropes synthesis continues until anode 5 is consumed. Then power system 17 is shut down, feeding system 19, gas re-circulation pump 14 and water-cooling system 18 are stopped and reaction vessel 1 is opened. Carbon soot from reaction vessel 1 and filtration system 13 is collected and subjected to known carbon allotropes recovering procedures. To provide continuous operation of the apparatus automatic anode changing system with multiple anode storage is used (not shown). After anode is consumed automatic anode changing system pulls electrodes apart, removes anode residue, installs new anode and automatically re-starts the process of carbon allotropes synthesis.

In order to eliminate completely carbonic deposit formed on cathode surface a preferable embodiment is furnished with device (not shown) capable temporarily to change the electrode polarity during operation. This action will convert previously non-consumable cathode into consumable anode to consume all developed carbonic deposit on cathode. When deposit is consumed, then polarity should be restored and the electrode system should regain the previous status.

In order to intensify a condensation rate of soot on reaction vessel walls, to reduce maximum heat load on reaction vessel body, make easier discharge of produced soot from the vessel and improve access to electrode changer, the water cooled reaction vessel has ability to be inclined to up to 120 degree with respect to vertical position. For this purpose the water cooled reactor chamber along horizontal axis at the center of gravity has attached two pivoting shaft ends resting on supports.

Performed experiments showed that maximum productivity and optimal yield can be achieved at constant specific evaporation rate of graphite anode about 1.5-2 g/cm2 per minute at corresponding gas outflow rate. In order to get maximum productivity, the designed electrode system should allow to maintain ratio between the gas outflow rate to the electrode evaporation rate by mass within 1 to 10.

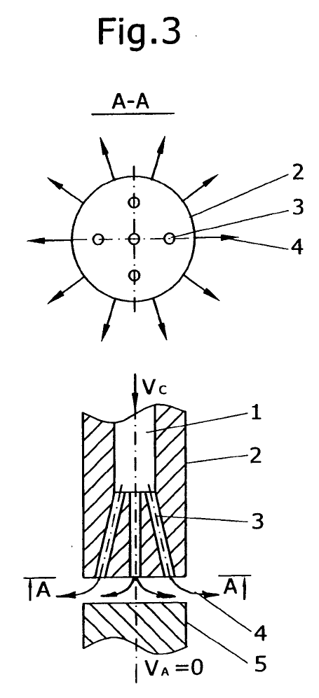

In addition to the apparatus of the present invention five preferred embodiments of electrode design are presented on FIG. 3-7. The first three preferred embodiments disclose the electrode designs, which can be employed as non-consumable cathodes in DC arc plasma process. The forth and fifth preferred embodiments disclose the electrode designs, which can be employed as consumable anodes in DC arc plasma process or as both electrodes in AC arc plasma process.

The first preferred embodiment of electrode design shown on FIG. 3 is intended for distribution of buffer gas flow within a cathode body to create more uniform radial gas outflow. In the first preferred embodiment buffer gas flow V_{C} is supplied to the longitudinal inner gas channel 1 of cathode 2. The single inner gas channel 1 branches out into several channels 3 of a smaller diameter and distributes buffer gas flow V_{C}. Buffer gas is injected through the multiple outlets of the channels 3 to the gap between cathode 2 and anode 5 and creates radial gas outflow 4, which removes carbon and catalytic vapors outward of the hot plasma zone. The first preferred embodiment of electrode design is limited neither by shape and size of cathode 3 nor by dislocation, arrangement, shape, size and number of multiple cathode channels 3 or any other modifications and changes in design.

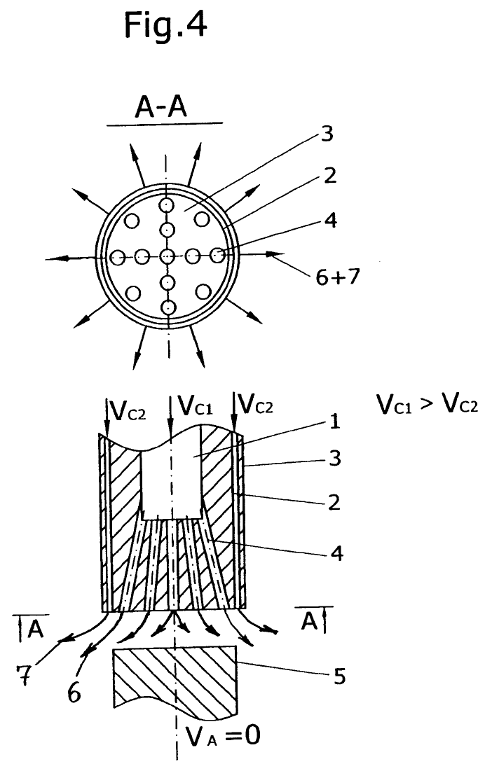

The second preferred embodiment of electrode design shown on FIG. 4 is intended for distribution of buffer gas flow within a cathode body to create more uniform radial gas outflow and to eliminate hard carbon deposit on cathode sidewalls caused by eddy gas flows. In the second preferred embodiment buffer gas flow V_{C1} is supplied to the longitudinal inner gas channel 1 of cathode 3 and the buffer gas flow V_{C2} is supplied to the annular gas channel 2. The channel 1 branches out into multiple channels 4 of a smaller diameter, which distribute buffer gas flow V_{C1}, injects it into the gap between cathode 3 and anode 5 and creates radial gas outflow 6 removing carbon and catalytic vapors outward of the hot plasma zone. Buffer gas flow V_{C2} injected through the annular gas channel 2 creates protective gas shield 7, which cuts off carbon vapor from cathode sidewalls and eliminates sidewall cathode deposit. Buffer gas flow coming out of the annular channel 2 has to have less velocity then buffer gas flow coming out of the multiple channels 4. This condition does not allow protective gas shield 7 to plug up the radial gas outflow 6 within the gap zone. To provide better gas dynamic in the gap the ratio between mean diameter of the annular cathode channel 2 and anode 5 diameter has to range from 1 to 1.3, which means the annular cathode channel 2 diameter has to be equal or rather more then anode 5 diameter. The second preferred embodiment of electrode design is not limited by geometry of cathode 3; by geometry, number and dislocation of the multiple channels 4; by dislocation of the annular channel 5 or by any other modifications and changes in design.

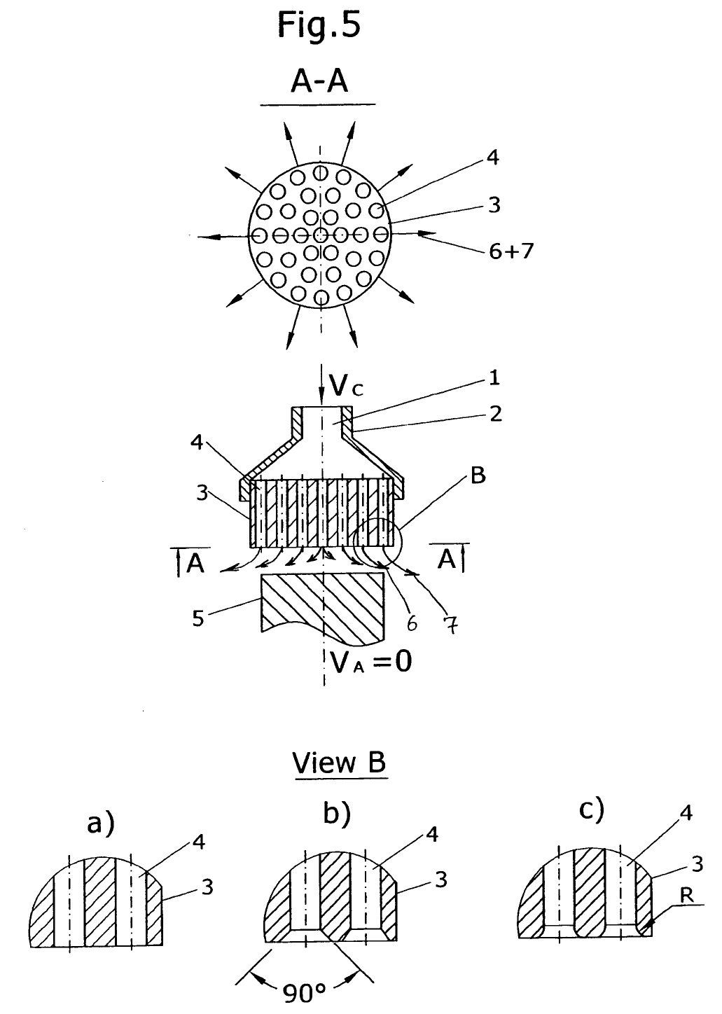

The third preferred embodiment of electrode design shown on FIG. 5 is intended for distribution of buffer gas flow within a cathode body to create more uniform radial gas outflow and to eliminate hard carbon deposit on cathode sidewalls caused by eddy gas flows. In the third preferred embodiment of electrode design buffer gas flow V_{C} is supplied to the longitudinal inner gas channel 1 of cathode holder 2. Parallel multiple gas channels 4 of distal cathode 3 distribute buffer gas flow V_{C} and inject it to the gap between cathode 3 and anode 5. Channels 4 positioned on a distal cathode face closer to the center of cathode face create radial gas outflow 6. Channels 4 positioned closer to the outer edge of the distal cathode surface create protective gas shield 7, which cuts off carbon vapor from cathode sidewalls and eliminates sidewall cathode deposit. The outlets of parallel multiple inner gas channels 4 of cathode 3 have cylindrical shape as shown on FIG. 5, a. To improve gas dynamic of buffer gas injection to the gap between electrodes the channel 4 outlets are chamfered, as shown on FIG. 5, b or machined to fillet shape, as shown on FIG. 5, c. The third preferred embodiment of electrode design is not limited by shape and size of cathode 3; by method of attaching cathode 3 to cathode holder 2; by arrangement, dislocation, shape, size and number of multiple channels 4; by shape of channel 4 outlets, their dimensions and depth or any other modifications and changes in design.

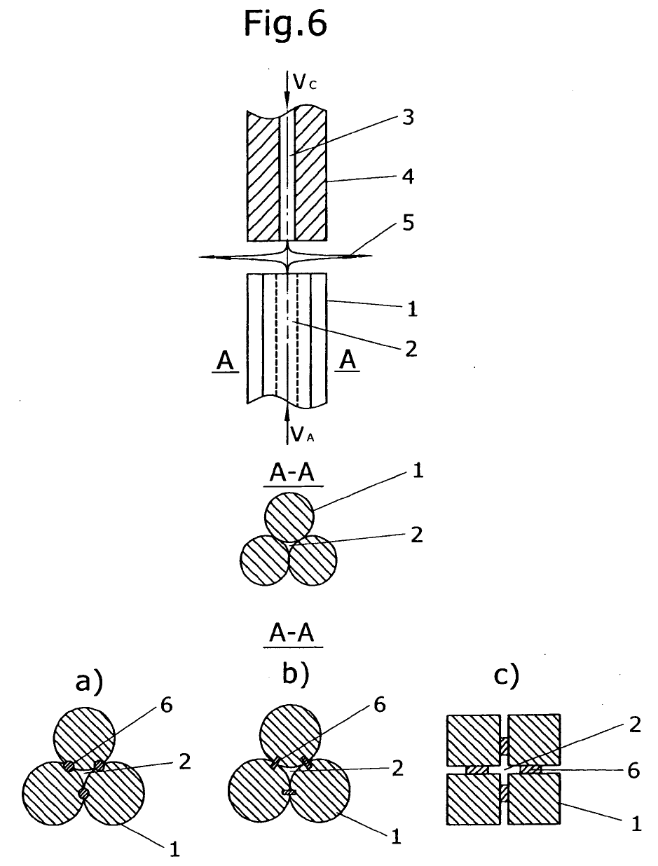

The fourth preferred embodiment of electrode design discloses the easy and inexpensive way of creating a longitudinal inner gas channel in an expendable anode when the main drive is to increase cross section of used anode and provides an alternative way of introducing metal catalyst in the form of wires or strips for carbon nanotubes synthesis. In the fourth preferred embodiment of electrode design shown on FIG. 6 an anode 1 represents the assembling of three parallel graphite rods, which are tightly clamped together by any means. Contacting longitudinal walls of the graphite rods compose inner gas tight channel 2. Gas flow V_{A} is supplied to the gas channel 2. Another gas flow V_{C} is supplied to the inner gas channel 3 of cathode 4. Both gas flows V_{A} and V_{C} create radial gas outflow 5. Catalyst for carbon nanotubes synthesis can be introduced as round metal wires or rectangular metal strips 6 inserted in the longitudinal direction alongside the contacting walls of the graphite rods 1 as shown on FIGS. 6a and 6b. Special grooves have to be manufactured in the graphite rods to insert the metal catalytic wires and strips 6, which also provide additional gas tightness of the inner gas channel 2. FIG. 6c shows the way metal wires and strips 6 inserted between rectangular graphite rods 1 create longitudinal inner gas channel 2 in anode without necessity to manufacture the grooves in the graphite rods 1. The fourth preferred embodiment of electrode design is not limited by shape, diameter, dislocation and number of graphite rods 1; by shape, diameter, dislocation and number of the metal wires and strips 6; by geometry of cathode (4), presence or absence of cathode inner gas channel 5 or any other modifications and changes in design.

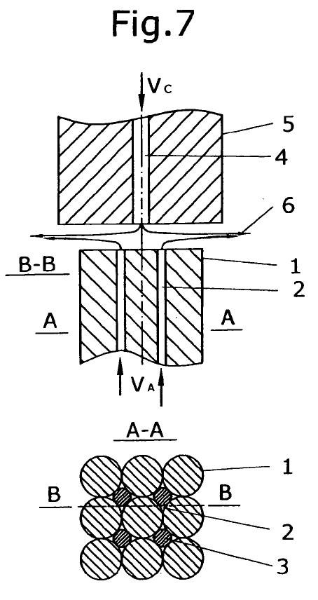

The fifth preferred embodiment of electrode design discloses the easy and inexpensive way of creating a multiple longitudinal inner gas channels in an expendable anode and provides an alternative way of introducing metal catalyst in the form of metal wires or strips for carbon nanotubes synthesis. In the fifth preferred embodiment of electrode design shown on FIG. 7 an anode 1 represents the assembling of nine parallel graphite rods with four metal wires 3 inserted between graphite rods in the longitudinal direction. Rods 1 and metal wires 3 are closely clamped together by any means. Metal wires 3 serve as a catalyst for the carbon nanotubes synthesis. Contacting walls of the graphite rods and metal wires compose multiple inner gas tight channels 2. Gas flow V_{A} is supplied to the gas channels 2. Another gas flow V_{C} is supplied to the inner gas channel 4 of cathode 5. Both gas flows V_{A} and V_{C} create radial gas outflow 6. The fifth preferred embodiment of electrode design is not limited by shape, diameter, dislocation and number of graphite rods 1; by shape, diameter, dislocation and number of the metal wires 3; by geometry of cathode 5, presence or absence of cathode inner gas channel 4 or any other modifications and changes in design.

### EXAMPLE 1

Process of fullerene synthesis was accomplished using the apparatus shown on FIG. 2. Reaction vessel with internal diameter 235 mm and length 600 mm was used. Both cathode and anode were made out of 580 Grade Graphite purchased by “Carbide/Graphite Group” with diameter 13 mm. Cathode had single central inner gas channel 1.5 mm in diameter. Initial masses of cathode and anode were measured and electrodes were attached to the corresponding electrode holders. The reaction vessel was assembled and purged by buffer gas according to the procedure described above. Helium of Zero Grade with the flow rate of 7.5 L/min was injected to the hot plasma zone through the single cathode channel, providing radial gas outflow. Reaction vessel pressure was maintaining at the level of 780 Torr.

Electrical current of 300 A, 29 VDC was applied to the electrode holders. The constant gap of about 5 mm between electrodes was automatically maintained during the process by adjusting of electrodes position. After 30 min of operation all carbon soot from the reaction vessel and filtration system was collected and thoroughly stirred to provide homogeneity of composition. Small sample of about 40 mg was taken and subjected to toluene extraction at room temperature during 20 min in ultrasonic bath. Toluene extract was filtrated and analyzed by HPLC-UV and HPLS-MS methods. The final fullerene mixtures contained 74% mass of C₆₀, 23% mass of C₇₀ and 3% mass of higher fullerenes.

During the arc plasma process 42.7 g of anode mass was evaporated and 7.1 g of cathode deposit has grown. 34.3 g of soot with average fullerene mix yield of 16.1% mass were collected. Calculated fullerene mix productivity was 11.0 g/hour.

### EXAMPLE 2

Example 2 was performed at exactly the same manner as the Example 1. Various levels of radial gas outflow were applied. The results are presented in the Table 1.

TABLE 1

| | | Anode | | | | |
|---|---|---|---|---|---|---|
| | Radial | mass | | Col- | | |
| | gas | evap- | Cathode | lected | Fullerene | Fullerene |
| Sample | outflow, | orated, | deposit, | soot, | yield, | productivity, |
| # | L/min | g | g | g | % mass | g/hour |
| 1 | 0 | 52.2 | 27.7 | 23.1 | 1.6 | 0.7 |
| 2 | 1 | 48.3 | 25.2 | 22.3 | 4.7 | 2.1 |
| 3 | 3 | 46.5 | 16.8 | 28.4 | 10.6 | 6.0 |
| 4 | 4.5 | 47.1 | 13.6 | 32.6 | 13.9 | 9.1 |
| 5 | 7.5 | 42.7 | 7.1 | 34.3 | 16.1 | 11.0 |

Table 1 indicates significant positive influence of radial gas outflow on the fullerene yield and fullerene productivity. Radial gas outflows more then 7.5 L/min were tended to blow up the arc. Radial gas outflows below 3 L/min were not enough to move carbon vapor effectively out of the hot plasma zone. In this case central cathode inner gas channel was partly blocked by growing deposit and was blocked completely at the absence of radial gas outflow.

### EXAMPLE 3

Example 3 was performed according to the same procedure as the Example 1 but different process parameters were applied. Multi-channel cathode design was applied (FIG. 3). Cathode with diameter 25 mm had 5 inner gas channels with round outlets 1.5 mm in diameter each. Anode with diameter 18 mm was applied. All process parameters and results are presented in the Table 2.

TABLE 2
Process Parameters

| | |
|---|---|
| Helium flow, L/min | 40 |
| Pressure, Torr | 800 |
| Current, A | 650 |
| Voltage, V | 34 |
| Total time, min | 12 |

Results

| | |
|---|---|
| Anode mass evaporated, g | 196.4 |
| Cathode deposit, g | 6.3 |
| Soot collected, g | 187.7 |
| Fullerene yield, % mass | 8.9 |
| Fullerene productivity, g/hour | 83.5 |

### EXAMPLE 4

Example 4 was performed according to the same procedure as the Example 1 but different process parameters were applied. Multi-channel cathode shown on FIG. 5 with diameter 38 mm had 13 cylindrical parallel inner gas channels 1.5 mm diameter each. The channels had chamfered outlets as shown of FIG. 5b with cone angle 120° and cylindrical hole 5.5 mm in diameter. Anode with diameter 25 mm was applied. All process parameters and results are presented in the Table 3.

TABLE 3
Process Parameters

| | |
|---|---|
| Helium flow, L/min | 75 |
| Pressure, Torr | 815 |
| Current, A | 1000 |
| Voltage, V | 41 |
| Total time, min | 10 |

Results

| | |
|---|---|
| Anode mass evaporated, g | 435.5 |
| Cathode deposit, g | 0 |
| Soot collected, g | 432.8 |
| Fullerene yield, % mass | 7.1 |
| Fullerene productivity, g/hour | 184.4 |

### EXAMPLE 5

Example 5 was performed in exactly the same manner as the Example 4 using the same process parameters. Experimental conditions were modified by introducing additional helium flow through the gas inlet 10, shown on FIG. 2 into the reaction vessel 1 at a rate of 75 L/min. All process parameters and results are presented in the Table 3.

TABLE 3
Process Parameters

| | |
|---|---|
| Pressure, Torr | 830 |
| Helium flow, L/min | 75 |
| Additional helium flow, L/min | 75 |
| Current, A | 1000 |
| Voltage, V | 41 |
| Total time, min | 10 |

Results

| | |
|---|---|
| Anode mass evaporated, g | 447.3 |
| Cathode deposit, g | 0 |
| Soot collected, g | 444.2 |
| Fullerene yield, % mass | 11.4 |
| Fullerene productivity, g/hour | 303.8 |

Tables 2, 3 and 4 show that injection of buffer gas to the gap between electrodes and creating a radial gas outflow removes principal limitations to scale up electric arc plasma process of carbon allotropes synthesis by applying higher electrical currents and electrodes of bigger diameters.

1. A method of carbon allotropes synthesis for use in a hot plasma zone of arc discharge plasma apparatus comprising the steps of:
selecting consumable and non consumable electrodes wherein at least one of said electrode having at least one longitudinal inner channel for delivering of a buffer gas outflow, feedstock material and catalyst to between electrode gap;
continuous feeding to the hot plasma zone the consumable electrode, feedstock material and catalyst admixed with the buffer gas outflow injected through the longitudinal inner channel of the electrode;
forming in the hot plasma zone a vapor from consumed materials;
removing from the hot plasma zone by the radial buffer gas outflow the produced vapor for quenching and condensing; and
forming and collecting of carbon allotropes contained soot.

2. The method as defined in claim 1, wherein the said continuous feeding of selected electrode, feedstock material and catalyst into the hot plasma zone is performed by moving of at least one consumable electrode towards the said hot plasma zone.

3. The method as defined in claim 1, wherein said consumable and non consumable electrodes used with DC current for developing a hot plasma zone periodically, during operation, for complete elimination of carbon deposit occurred on cathode are assigned alternative functions by temporarily switching a polarity of said electrodes.

4. A method as defined in claim 1, wherein said inert gas selected from the group consisting of helium only, mixture of helium with up to 20% of argon, and mixture of helium with up to 10% of nitrogen.

5. The method as defined in claim 1, wherein the said vapor being removed from the hot plasma zone to a volume of reaction vessel by force of buffer gas outflow for increasing productivity, yield and completely eliminating a cathode deposit.

6. The method as defined in claim 1, wherein a produced carbon soot contains at least one molecule of fullerene and/or at least one carbon nanotube.

7. A DC arc discharge plasma apparatus for fullerenes and nanotubes synthesis comprising:
a water cooled reaction vessel,
an electrode system sealed in said reaction vessel,
wherein said electrode system having anode and cathode with at least one longitudinal inner channels therein for creating buffer gas outflow, feeding feedstock and catalyst through said longitudinal inner channels to a hot plasma zone and also for removing of produced vapor from the hot plasma zone by said buffer gas outflow.

8. The DC arc discharge plasma apparatus for fullerenes and nanotubes synthesis according to claim 7 further comprising:
a device for alternative temporarily changing polarity of electrodes during operation for removing cathode deposit.

9. The DC arc discharge plasma apparatus for fullerenes and nanotubes synthesis, according to claim 7, further comprising a filtration and gas re-circulation means to separate carbon soot from inert gas.

10. The DC arc discharge plasma apparatus according to claim 7, wherein said anode and cathode have different cross sectional areas comprising differently assembled blocks, said blocks shape consisting of rods, bars and rods and bars, where said rods, bars and rods and bars are assembled in tight contact along longitudinal sides to form inner longitudinal channel.

11. The DC arc discharge plasma apparatus according to claim 7, wherein said cathode comprising distal end with outlet holes, said distal end with outlet holes being connected with said longitudinal inner channel to uniformly distribute buffer gas outflow in the hot plasma zone.

12. The cathode of the said electrode system according to claim 7, wherein said cathode comprising an additional peripheral annular gas channel to block a side carbon deposit on a cathode surface.

13. The apparatus according to claim 11, wherein said outlet holes in order to improve gas dynamic of the gas outflow injected into the hot plasma zone have a specially shaped chamfered, fillet or cylindrically straight hole ends.

14. The apparatus as defined in claim 10, wherein said block assembled anode has inserts of metallic catalytic wires or strips.

15. The DC arc discharge plasma apparatus for fullerenes and nanotubes synthesis according to claim 7 wherein said electrode system in order to achieve maximum productivity and optimal yield should allow to maintain a ratio by mass between buffer gas outflow rate and anode evaporation rate within 1 to 10.

16. A DC arc discharge plasma apparatus for fullerenes and nanotubes synthesis comprising:
a water cooled reaction vessel;
an electrode system sealed in said reaction vessel;
wherein said electrode system having anode and cathode with at least one longitudinal inner channels therein for creating buffer gas outflow, feeding feedstock and catalyst through said longitudinal inner channels to a hot plasma zone and also for removing of produced vapor from the hot plasma zone, wherein said cathode comprising an additional peripheral annular gas channel to block a side carbon deposit on a cathode surface and wherein said cathode comprising distal end with outlet holes, said distal end with outlet holes being connected with said longitudinal inner channel to uniformly distribute buffer gas outflow in the hot plasma zone;
a feeding system to provide continuous consumption of anode and inflow of feedstock and catalyst admixed with buffer gas outflow;
a device for alternative change of electrodes polarity;
a filtration and gas re-circulation means to separate carbon soot from inert gas;
and a device for inclination of reaction vessel with respect to vertical position;

17. The DC arc discharge plasma apparatus according to claim 16, wherein said reaction vessel being mounted pivotably on a stationary support for said reaction vessel inclination around horizontal axis up to 120 degree with respect to vertical position.
